(19) United States
(12) Patent Application Publication
(10) Pub. No.: US 2010/0156061 A1
(43) Pub. Date: Jun. 24, 2010

(54) CONNECTION OF A SUSPENSION STRUT TO A WHEEL CARRIER OF A MOTOR VEHICLE

(75) Inventors: Raphael Fischer, Schweinfurt (DE); Peter Niebling, Bad Kissingen (DE); Christian Hecker, Schweinfurt (DE); Darius Dlugai, Schweinfurt (DE)

Correspondence Address: LUCAS & MERCANTI, LLP, 475 PARK AVENUE SOUTH, 15TH FLOOR, NEW YORK, NY, 10016, US

(73) Assignee: SCHAEFFLER KG, Herzogenaurach (DE)

(21) Appl. No.: 12/063,297

(22) PCT Filed: Aug. 2, 2006
(86) PCT No.: PCT/DE2006/001345

§ 371 Date: Feb. 8, 2008

(30) Foreign Application Priority Data
Aug. 10, 2005 (DE) 10 2005 037 737.8

(51) Int. Cl. B60G 3/06

(52) U.S. Cl. 280/124.134

(57) ABSTRACT

The invention relates to a connection of a suspension strut to a wheel carrier of a motor vehicle, wherein the wheel carrier is provided with a fixture for the releasable connection of a lower end of the suspension strut, and wherein the lower end of the suspension strut is mounted coaxially in the fixture. In order to improve this suspension strut connection, it is provided that the wheel carrier is a sheet-metal formed part on which the fixture of the suspension strut is integrally formed as a single piece, wherein retaining means which can be connected releasably to retaining means of the suspension strut are integrally formed on the fixture.

### FIELD OF THE INVENTION

The invention relates to the connection of a suspension strut of a wheel carrier of a motor vehicle, the wheel carrier being provided with a receptacle for the releasable connection of a lower end of the suspension strut, and the lower end of the suspension strut being mounted coaxially in the receptacle.

### BACKGROUND OF THE INVENTION

DE 43 17 057 A1 discloses such a connection of a suspension strut to a wheel carrier of a motor vehicle, in which the connection of the suspension strut to the wheel carrier takes place by means of a tension strap, the tension strap which surrounds the suspension strut being screwed to the wheel carrier by means of threaded nuts. The threaded nuts of the screws are arranged at a vertical distance from one another in a common holder and are held between an inner and an outer stop section of the holder via a flange designed with a larger diameter than that of the nuts. One disadvantage of a solution of this type is that the fixing of the suspension strut to the wheel carrier cannot be implemented with acceptable tensions. Furthermore, the tension strap forming a receptacle constitutes a separate component.

DE 35 35 287 C2 discloses an inseparable connection of a suspension strut and wheel carrier or the axle pin, in which connection the suspension strut and the wheel carrier are connected to one another by means of a weld. Although such a solution is optimal for the absorption of forces, it is nevertheless not preferred by automobile manufacturers, since, in terms of maintenance and repair, they prefer releasable connections.

EP 1 355 080 A1 discloses a connection of a suspension strut to a cast wheel carrier with a conical suspension strut seat, in which connection axial screwing to the wheel carrier is carried out.

All the abovementioned solutions have in common that they are optimized for connection to cast wheel carriers in terms of implementability, tolerance, strength, mountability and cost. The configuration of a corresponding receptacle of a wheel carrier, which is produced as formed part, is complicated in manufacturing terms since the small material thickness gives rise to excessive stresses which are to be avoided.

Automobile manufacturers increasingly desire to produce the wheel carrier not as a casting, but as a formed part. However, the configuration of a corresponding receptacle on a wheel carrier produced as a formed part has hitherto not met with satisfactory success, since the strength and rigidity of the connection of the wheel carrier to the suspension strut are, in wheel carriers produced as a formed part, a particular problem which has hitherto been solved only inadequately.

### OBJECT OF THE INVENTION

Against this background, the object on which the invention is based is to optimize the connection of a suspension strut to a wheel carrier, particularly with regard to manufacturing aspects, and at the same time to obtain a connection of a suspension strut to a wheel carrier which is suitable for reliably absorbing all forces taking effect and which ensures a stable and permanent connection of the suspension strut to the wheel carrier. Furthermore, the connection is to be optimized in terms of maintenance, repair and the exchangeability of the suspension strut.

### SUMMARY OF THE INVENTION

The solution for achieving this object arises from the features of the main claim, while advantageous refinements and developments of the invention may be gathered from the subclaims.

The invention is based on the realization that, in a wheel carrier, the set object can be achieved when the latter is produced as a sheet metal formed part, onto which the receptacle of the suspension strut is formed in one piece, the receptacle having formed onto it holding means which are connectable releasably to holding means of the suspension strut.

Accordingly, the invention proceeds from a connection of a suspension strut to a wheel carrier of a motor vehicle, the wheel carrier being provided with a receptacle for the releasable connection of a lower end of the suspension strut, and the lower end of the suspension strut being mounted coaxially in the receptacle. To achieve the set object, the invention provides for the wheel carrier to be a sheet metal formed part, onto which the receptacle of the suspension strut is formed in one piece, the receptacle having formed onto it holding means which are connectable releasably to holding means of the suspension strut.

The object is therefore achieved in a surprisingly simple way in that the receptacle of the suspension strut is integrated into the wheel carrier produced as a formed part.

The wheel carrier produced as a formed part can normally be connected to further axle components, that is to say to a wheel bearing, a brake connection and a steering arm and its connection.

Moreover, there may be provision for the holding means of the receptacle to be formed on an axially upper end of the receptacle. Alternatively to this, there may be provision for the holding means of the receptacle to be formed on an axially lower end of the receptacle. It is likewise conceivable, in a development of the invention, that the holding means of the receptacle are formed on an axially lower end and on an axially upper end of the receptacle.

Correspondingly, according to developments of the invention, there may be provision for the holding means of the suspension strut to be formed on an axially upper end of the suspension strut or else for the holding means of the suspension strut to be formed on an axially lower end of the suspension strut. It is also advantageous if the holding means of the suspension strut are formed on an axially upper end and on a lower end of the suspension strut.

In practical developments of the invention, there may be provision for the holding means of the receptacle to be connectable to the holding means of the suspension strut by means of a screw connection, while, in particularly preferred refinements of the invention, there may be provision for the screw connection to have a threaded bolt, a tangential screw, a radial screw or a screw cap.

In another usable refinement of the invention, there may be provision for the holding means of the receptacle to be connectable to the holding means of the suspension strut by means of at least one claw ring.

In a refinement alternative to this, there may be provision, instead, for the holding means of the receptacle to be connectable to the holding means of the suspension strut by means of at least one V-band.

In a particularly advantageous development of the invention, there is provision for the holding means of the receptacle to be formed by a longitudinal slot and at least one bore, and for the holding means of the suspension strut to be formed by a screw bolt which can be led through the at least one bore. If appropriate, a clearance, in particular a groove, for the at least partial reception of the screw bolt for pull-out protection or for axial securing may be provided on the suspension strut.

In a further expedient development of the invention, there may be provision for the holding means of the receptacle to be designed as a reception cup with a shoulder and with a bore, through which a threaded bolt of the suspension strut can be led, and for the holding means of the suspension strut to be a threaded bolt, the nut of which can be tensioned against the receptacle. This version can be supplemented by arranging around the casing of the suspension strut a draw-in sleeve. If required, the latter can be used as an adapter between the existing wheel carrier and existing suspension strut.

In another refinement of the invention, there is provision for the wheel carrier to have a receptacle with a double cone which consists of an upper conically widened mouth and of a conical shoulder of a reception cup, the mouth and the shoulder forming the holding means of the receptacle.

This refinement can be combined with another development which is distinguished in that the suspension strut has a casing with a rib, the collar of which bears against the conically widened mouth of the reception cup, while a shoulder of the lower end of the casing bears against the shoulder of the wheel carrier.

In a variant of this refinement which is alternative to this, there may be provision for the receptacle of the wheel carrier to have a reception cup with a conically designed upper mouth, against which is supported a conical portion of the suspension strut (5), in particular formed by an, in particular, double-conical ring (35) or a conically shaped portion of the suspension strut (5).

This refinement may be developed, furthermore, in that the reception cup either is connected by means of a weld to the wheel carrier or is formed in one piece onto the latter.

According to a further preferred refinement, there may be provision, furthermore, for a lower end of the reception cup to be angled radially inward such that it forms a radially inwardly-directed conical seat surface for a conical disk which is braced against the conical seat surface of the lower end of the reception cup by means of a threaded bolt and a nut.

In another practical development of the invention, there may be provision for a lower end of the reception cup to be angled radially outward and form a conical seat surface for a holding means of the suspension strut, the holding means being designed as an annular sleeve with collar, which annular sleeve is acted upon with pressure by the nut, or, alternatively to this, for a lower end of the reception cup to be angled radially outward and to form a conical seat surface for a holding means of the suspension strut, the holding means being designed as a conical ring which is acted upon with pressure by a cup spring. It is likewise possible for the holding means to be designed as a double-conical ring, one conical surface of which presses against the lower end and the other conical surface of which presses against a slope of the suspension strut.

In a further refinement of the invention, there may be provision for the receptacle to have radially on the outside, as a holding means, a double edging with at least one bore which is in alignment with at least one bore of at least one tab formed on the suspension strut, the tab being the holding means of the suspension strut and being connectable to the edgings preferably by means of a screw.

In one modification of the invention, there may be provision for the suspension strut to have a receptacle which is connectable to the receptacle of the wheel carrier, the receptacle of the suspension strut having beads and/or bosses which, together with correspondingly shaped bosses and/or beads of the receptacle of the wheel carrier, form an antitwist device.

This refinement may be developed in that the receptacle of the suspension strut forms the casing of the suspension strut.

In a further practical refinement of the invention, there is provision for a screw led tangentially through the wheel carrier to be the holding means of the suspension strut, a recess being provided in the casing of the suspension strut and a recess being provided in the receptacle of the wheel carrier, through which recesses the screw is led.

Alternatively to this, there may be provision for the screw to be led radially through a threaded bore delimited by sheet metal tabs of the receptacle and to engage into a depression in the casing of the suspension strut.

In one expedient development of the invention, there is provision for a claw ring to be used for holding the lower end of the suspension strut axially in the receptacle of the wheel carrier. This claw ring, preferably produced as a formed part, may, in practice, be configured such that it has inwardly-directed claws and radially outwardly-directed claws which bear against a lower edge of the receptacle of the wheel carrier, the radially inwardly-directed claws latching into a recess in the casing, and an upper end edge of the claw ring being mounted in a step of the casing.

In a modification of the last-mentioned refinement, there may be provision for the radially outwardly-directed claws to bear against a lower edge of the wheel carrier, the radially inwardly-directed claws engaging into a recess in the casing, and an upper end edge of the claw ring being mounted in a step of the casing.

In a development of this refinement which is alternative to this, there may be provision for a claw ring to have an S-shaped cross-sectional shape and be capable of being introduced at least partially on a lower end of the receptacle of the wheel carrier, the lower end being bent over in such a way as to give rise to a bearing ring for the lower end face of the casing of the suspension strut.

In another advantageous development of the invention, there may be provision for the lower end of the receptacle of the wheel carrier to be bent over in such a way as to form a bearing ring for the end face of the suspension strut, a bolt of the suspension strut being fixed axially by clamping rings, and, furthermore, there may be provision for the clamping ring to be designed as a shaft securing ring or as a spring ring, the clamping ring latching into a corresponding groove in the bolt.

Furthermore, in a further design variant of the invention, there may be provision, in a lower region of the suspension strut, for an internal thread to be incorporated, into which a screw cover is screwed, with the result that the suspension strut is fixed to the wheel carrier.

In a similar refinement, it is possible that a thread, into which a screw cover is screwed, is incorporated into the lower region of the casing of the suspension strut.

A margin of the screw cover may in this case project radially beyond the suspension strut and form a tension surface for a conical ring.

In another refinement of the invention, there is provision for the lower end of the wheel carrier to be bent outward into a set-out cone, and for the suspension strut to have at its lower end an external thread onto which a nut is screwed which forms a tension surface for the conical ring which is brought at least partially to bear against the set-out cone.

In a further refinement of the invention, there may be provision for the lower end of the wheel carrier to be bent outward into a set-out cone, the suspension strut being provided in its casing with a wedge-shaped groove into which claws of a conical ring engage.

In another development of the invention, there may be provision for the wheel carrier to have an upper end with a conically widened mouth, and for the suspension strut to have a double-conical ring, or another correspondingly shaped portion on the suspension strut, the mouth and the double-conical ring or shaped portion being positively connected to one another and secured axially by means of a V-band.

In a modified refinement of the invention, there may be provision for a lower end of the wheel carrier to be bent inward into a cylindrical seat or into a conical seat surface for the suspension strut, a groove being introduced into the casing, into which groove a V-band engages, with the result that the suspension strut is tensioned and secured axially against the wheel carrier.

In a similar development of the invention, there is a provision for the lower end of the receptacle of the wheel carrier to be bent radially outward into a set-out cone, the cone having inserted into it a bevel ring which is braced against the wheel carrier, by means of a V-band, the tip of which engages into the groove, and secures the suspension strut to the wheel carrier.

Finally, in a further refinement of the invention, there may be provision for a V-band to be arranged on the receptacle and on the suspension strut such that one leg of the V-band surrounds the set-out cone, while another leg engages into the groove of the suspension strut and secures the axial connection of the suspension strut to the receptacle of the wheel carrier.

### BRIEF DESCRIPTION OF THE DRAWINGS

To illustrate the invention, the description is accompanied by a drawing of exemplary embodiments in which:

FIG. 1 shows a perspective partial view of a first exemplary embodiment of a connection according to the invention of a suspension strut to a wheel carrier,

FIGS. 2a to 2b show a second exemplary embodiment of a connection according to the invention of a suspension strut to a wheel carrier in a longitudinal section,

FIG. 3 shows a third exemplary embodiment of a connection according to the invention of a suspension strut to a wheel carrier in a longitudinal section,

FIGS. 4a to 4c show a fourth exemplary embodiment of a connection according to the invention of a suspension strut to a wheel carrier in longitudinal section,

FIGS. 5a to 5b show a fifth exemplary embodiment of a connection according to the invention of a suspension strut to a wheel carrier in longitudinal section and in a perspective view,

FIGS. 6a to 6c show a sixth exemplary embodiment of a connection according to the invention of a suspension strut to a wheel carrier in longitudinal section,

FIGS. 7a to 7b show a seventh exemplary embodiment of a connection according to the invention of a suspension strut to a wheel carrier in longitudinal section,

FIGS. 8a to 8b show an eighth exemplary embodiment of a connection according to the invention of a suspension strut to a wheel carrier in longitudinal section,

FIG. 8c shows a detail from FIGS. 8a and 8b in a perspective partial view,

FIGS. 9a to 9b show a ninth exemplary embodiment of a connection according to the invention of a suspension strut to a wheel carrier in longitudinal section,

FIG. 9c shows a detail from FIGS. 9a and 9b in a perspective partial view,

FIGS. 10a to 10b show a tenth exemplary embodiment of a connection according to the invention of a suspension strut to a wheel carrier in longitudinal section,

FIG. 11 shows an eleventh exemplary embodiment of a connection according to the invention of a suspension strut to a wheel carrier in longitudinal section,

FIGS. 12a to 12b shows a twelfth exemplary embodiment of a connection according to the invention of a suspension strut to a wheel carrier in longitudinal section,

FIGS. 12c to 12e show a detail from FIGS. 12a and 12b in various views,

FIG. 13a shows a thirteenth exemplary embodiment of a connection according to the invention of a suspension strut to a wheel carrier in longitudinal section,

FIG. 13b shows a detail from FIG. 13a in longitudinal section, and

FIGS. 14a to 14d show a fourteenth exemplary embodiment of a connection according to the invention of a suspension strut to a wheel carrier in longitudinal section,

FIGS. 15a,b show a further exemplary embodiment of a connection according to the invention of a suspension strut to a wheel carrier in longitudinal section and the connection has a detail in section.

### DETAILED DESCRIPTION OF THE DRAWINGS

Accordingly, a wheel carrier 1 is illustrated in perspective in a partial view in FIG. 1. The wheel carrier 1, which is produced as a sheet metal formed part, has a receptacle 2 for connection to a suspension strut, not illustrated in FIG. 1. The wheel carrier 1 has, moreover, a longitudinal slot 3 which serves for reducing the stiffening in the clamping direction. Bores 4 arranged on both sides serve for leading through screws, not illustrated, by means of which the suspension strut is clamped to the wheel carrier 3.

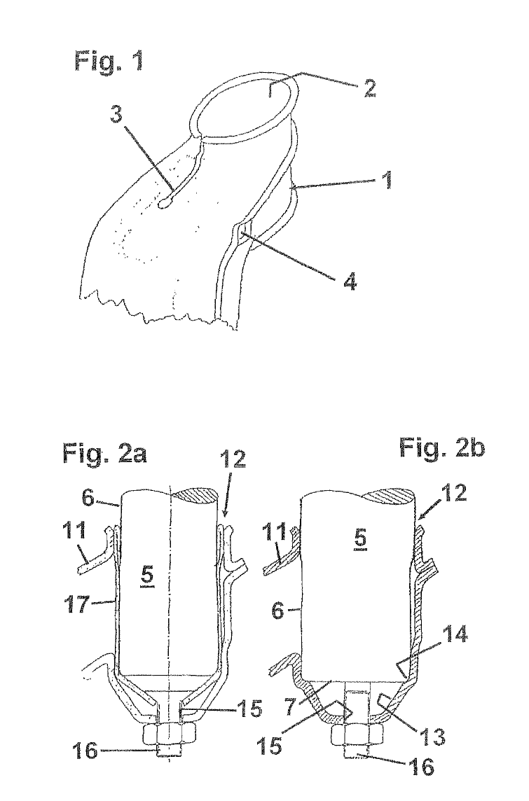

FIGS. 2a and 2b illustrate a second exemplary embodiment of a connection according to the invention of a suspension strut 5 to a wheel carrier 11. The wheel carrier 11 has a receptacle 12 of essentially round cross section which issues into a reception cup 13 having a shoulder 14. The reception cup 13, which forms the holding means formed onto the wheel carrier 11, has, furthermore, a bore 15 through which a threaded bolt 16 of the suspension strut 5 can be led.

In the exemplary embodiment illustrated in FIG. 2a, a casing 6 of the suspension strut 5 is surrounded by a draw-in sleeve 17 consisting of thin sheet metal, the draw-in sleeve 17 serving for easier mounting of the suspension strut 5 into the receptacle 12 of the wheel carrier 11. The suspension strut 5 is pressed in by the threaded bolt 16 being drawn in or via an axial screw, the threaded bolt 16 constituting the holding means formed onto the suspension strut 5. In the modification of the suspension strut 11, as illustrated in FIG. 2b, connection takes place without a draw-in sleeve. Here, a lower end face 7 of the casing 6 lies directly on the shoulder 14.

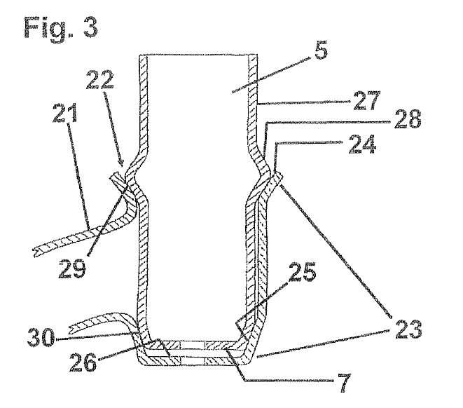

A third exemplary embodiment of the connection of a suspension strut 5 to a wheel carrier 21 is illustrated in FIG. 3. This wheel carrier 21 has a receptacle 22 with a double cone 23 which consists of an upper conically widened mouth 24 and of a conical shoulder 25 of a reception cup 26. The mouth 24 and shoulder 25 form the holding means formed onto the wheel carrier 21.

The suspension strut 5 has a casing 27 with a rib 28 which is generated, for example, by upsetting and a collar 29 of which bears against the conically widened mouth 24. A shoulder 30 of the lower end of the casing 27 bears against the shoulder 25 of the wheel carrier 21. The suspension strut 5 is fixed to the wheel carrier 21 from below by means of a threaded bolt, not illustrated.

In the solution according to FIG. 3, the vertical load which occurs is absorbed via the upper cone or via the mouth 24, the lower cone or the shoulder 25 serving for securing the suspension strut 5 radially in the receptacle 22 of the wheel carrier 21. In this solution, the draw-in length can be reduced, thus making it easier to release the suspension strut 5 in the event of repair.

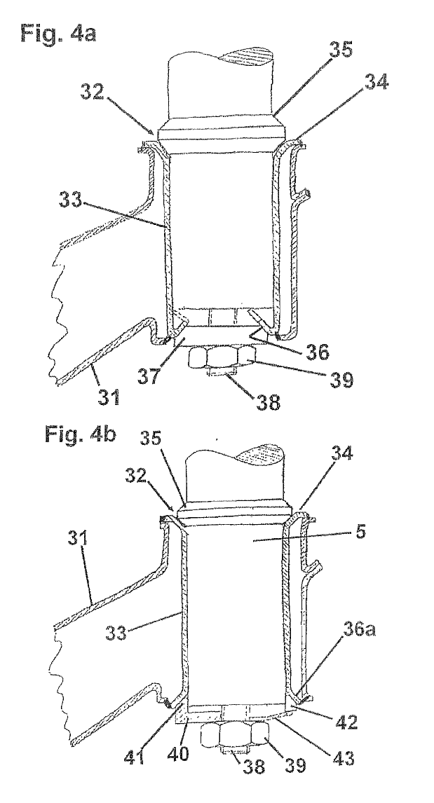

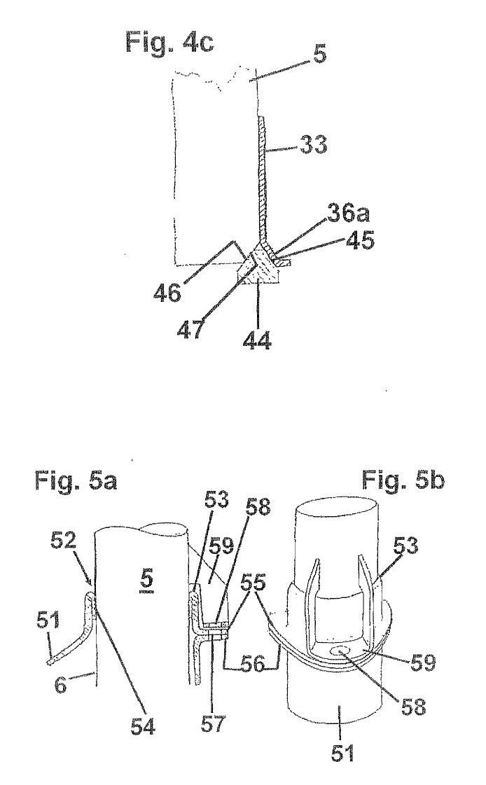

FIGS. 4a to 4c illustrate further exemplary embodiments, in which the holding means of a wheel carrier 31, like the wheel carrier from FIG. 3, have conical seat surfaces. According to FIGS. 4a to 4c, a receptacle 32 of the wheel carrier 31 has a reception cup 33 with a conically designed upper mouth 34, against which a double-conical ring 35 of the suspension strut 5 is supported. The reception cup 33 is formed onto the wheel carrier 31, the latter being connected to the wheel carrier 31 by means of a weld, as illustrated, or can be formed onto said wheel carrier in one piece by forming.

In FIG. 4a, a lower end 36 of the reception cup 33 is angled inward, so that it forms an inwardly-directed conical seat surface for a conical disk 37. The conical disk 37 is braced against the conical seat surface of the lower end 36 of the reception cup 33 by means of a threaded bolt 38 and a nut 39. As indicated by dashed lines in the left half of FIG. 4a, the lower end 36 of the reception cup 33 may be folded round in order, if required, to support the sheet metal margins additionally. The mouth 34 and the lower end 36 together form cones set opposite to one another, the upper cone absorbing vertical forces and the lower cone serving for centering the suspension strut 5.

FIG. 4b illustrates a variant similar to the embodiment shown in FIG. 4a. In this, a lower end 36a is angled radially outward and forms a conical seat surface for the holding means of the suspension strut 5. This holding means either may be designed, according to the left half of FIG. 4b, as an annular sleeve 40 with collar 41, which is acted upon by the nut 39, or, as illustrated in the right half of FIG. 4b, may be designed as a conical ring 42 which is pressed against by a cup spring 43.

FIG. 4c illustrates in detail an embodiment which is similar to the exemplary embodiment shown in FIG. 4b. Here, for locking against the lower end 36a of the reception cup 33, a double-conical ring 44 is used, one conical surface 45 of which presses against the lower end 36a and the other conical surface 46 of which presses against a slope 47 of the suspension strut 5.

FIGS. 5a and 5b illustrate a fifth exemplary embodiment of the connection of the suspension strut 5 to a wheel carrier 51 having a receptacle 52. Only an upper region 53 of the wheel carrier 51 is shown in these figures. The corresponding lower region, not illustrated, may have a configuration, as illustrated in FIGS. 1 to 4 and FIGS. 8 to 14.

An upper end 54 of the receptacle 52 is bent over or crimped round inwardly for stiffening purposes. The casing 6 of the suspension strut 5 bears against this upper end. The receptacle has radially on the outside a double edging 55 and 56 which are configured such that the edgings 55, 56 lie parallel to one another and at least approximately at right angles to the longitudinal axis of the suspension strut 5. Through the edgings 55, 56 a bore 57 is led which is in alignment with a bore 58 of a tab 59. While the edgings 55, 56 form the at least upper holding means of the wheel carrier 51, the tab 59 constitutes the at least upper holding means of the suspension strut 5. The tab is formed onto the casing 6 of the suspension strut 5, namely either in one piece by means of sheet metal forming processes or by means of a welded or soldered joint, as illustrated in FIGS. 5a and 5b.

A screw connection may be led through the bores 57 and 58. It is also possible, however, to lead a rivet connection through the bores 57, 58 in order to connect the wheel carrier 51 and suspension strut 5. FIGS. 5a and 5b illustrate a one-sided connection by means of the edgings 55, 56 and the tab 59. It is also conceivable, however, to have a corresponding at least two-sided arrangement which may be expedient, in order to achieve, under an axial pull, a symmetrical conduction of force between the suspension strut 5 and wheel carrier 51.

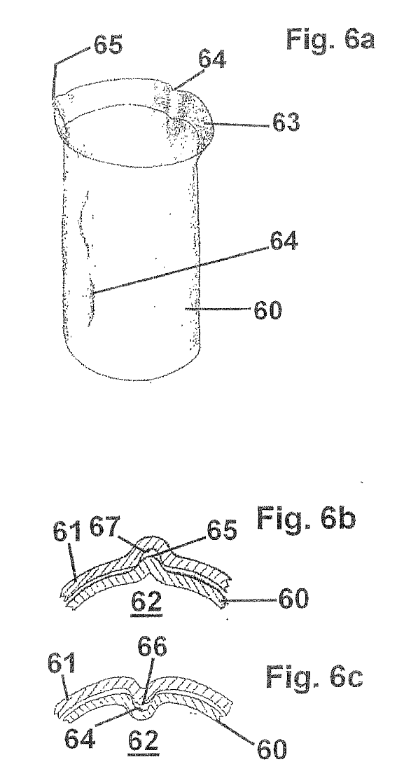

FIGS. 6a to 6c illustrate a detail of a wheel carrier and suspension strut, in this case with a receptacle 60 on the suspension strut 5. The receptacle 60 of the suspension strut is connectable to the receptacle of the wheel carrier 61.

However, the receptacle 60 may also form the lower casing of the suspension strut 5 and be connected in one piece to the suspension strut.

The receptacle 60 has a mouth 63 widened conically radially outward and also pressed-in depressions or beads 64 or pressed-out elevations or bosses 65 which, together with correspondingly shaped bosses 66 or beads 67 of the wheel carrier 61, form an antitwist device or mounting aid.

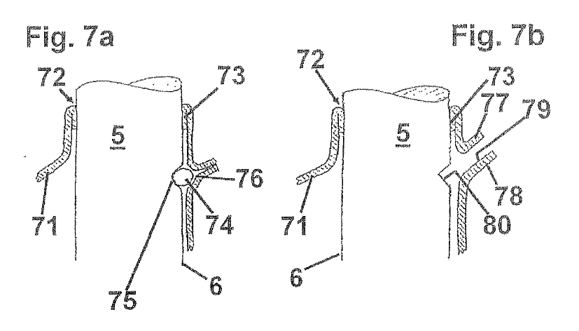

FIGS. 7a and 7b illustrate a seventh exemplary embodiment of a connection according to the invention of a wheel carrier 71 to the suspension strut 5. The wheel carrier 71 has a receptacle 72, the upper ends 73 of which are bent inwardly in a similar way to the exemplary embodiment shown in FIGS. 5a and 5b. The casing 6 of the suspension strut 5 comes to bear against these upper ends.

According to the variant of FIG. 7a, a screw 74 led tangentially through the wheel carrier 71 constitutes the holding means for the suspension strut 5, a correspondingly shaped recess 75 being provided in the casing 6 of the suspension strut 5 and the recess 76 being provided in the wheel carrier 71, through which recesses the screw 74 is led and secures the suspension strut 5 to the wheel carrier 71.

The reception bore of the suspension strut, moreover, may be remachined by cutting. In FIG. 7b, a screw, not illustrated, is led radially through a threaded bore 79 delimited by sheet metal tabs 77, 78 and comes to bear in a suitably shaped recess or depression 80 in the casing 6 of the suspension strut 5 and thus fixes the suspension strut 5 to the wheel carrier 71.

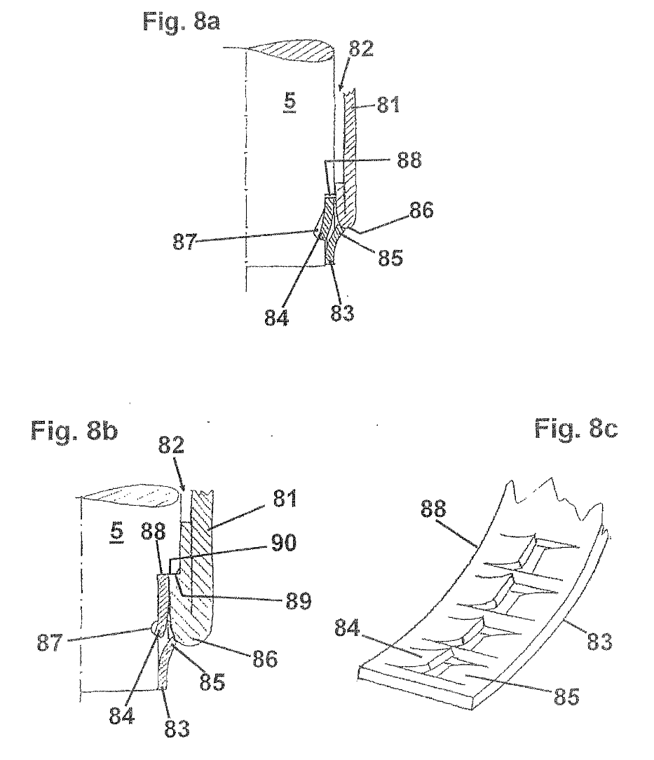

FIGS. 8a to 8c show an eighth exemplary embodiment in which a claw ring 83 is used for holding the lower end of the suspension strut 5 axially in a receptacle 82 of a wheel carrier 81. This claw ring 83 is illustrated in detail in a perspective view in FIG. 8c. The claw ring 83, which is expediently produced as a formed part, has inwardly-directed claws 84 and outwardly-directed claws 85. The radially outwardly-directed claws 85 bear against the lower edge 86 of the wheel carrier 81, while the radially inwardly-directed claws 84 snap into a recess 87 in the casing 6, an upper end edge 88 of the claw ring 83 being mounted with play in a step 89 of the casing 6. In the exemplary embodiment shown in FIG. 8b, the lower end 86 of the wheel carrier 81 also has a step 90 on which the step 89 of the casing 6 partially comes to lie.

The demounting of the claw ring 83 from FIG. 8a expediently takes place by means of a press-out sleeve which lays down the claws 85 and makes it possible to remove the suspension strut 5 from the wheel carrier 81. The claw ring 83 and the surfaces against which it bears or on which it engages may be configured such that, during operation, the claws 84, 85 become increasingly fixed. This may be achieved in that the selected radius in the recess 87 is smaller than the circular path described by the claws 84 during springing.

In the embodiment shown in FIG. 8b, the demounting of the suspension strut 5 from the wheel carrier 81 may take place by the claw ring 83 being parted.

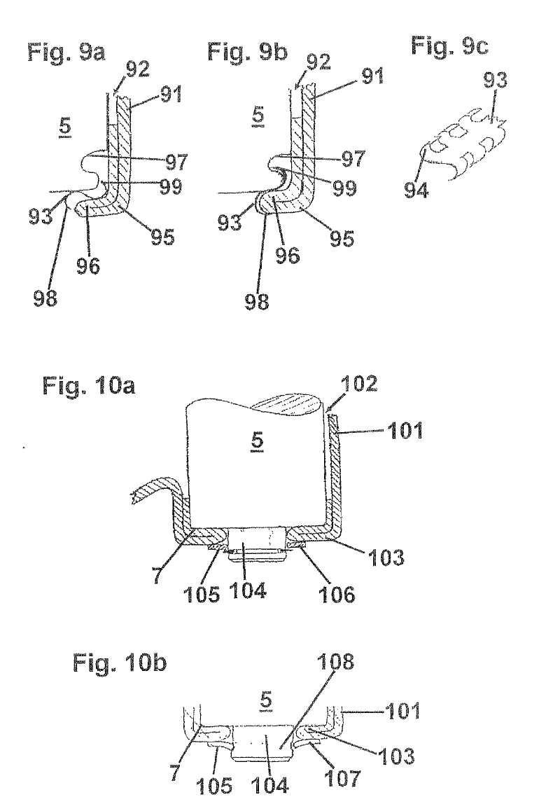

FIGS. 9a and 9b illustrate a ninth exemplary embodiment of a connection according to the invention of the suspension strut 5 to a wheel carrier 91 having a receptacle 92. As in the wheel carrier 81 of FIGS. 8a to 8c, the holding means is formed by a claw ring 93, although this claw ring 93 has a completely different cross-sectional shape, to be precise an S-shape. The claw ring 93, a detail of which is illustrated in FIG. 9c in a perspective view, is likewise a sheet metal formed part and consists of a line-up of S-shaped hook elements 94. A lower end 95 of the wheel carrier 91 is bent over in such a way as to give rise to a bearing ring 96 for the lower end face 7 of the casing 6 of the suspension strut 5. The casing 6 of the suspension strut 5 has a radial recess 97 into which the claw ring 93 can latch.

FIG. 9a illustrates the pressing of the suspension strut 5 into the receptacle 92 of the wheel carrier 91, specifically shortly before completion, that is to say a state in which the end face begins to exert pressure on the claw ring. FIG. 9b illustrates the conclusion of the pressing-in operation; as a result of the pressure of the end face 7, the hook elements have rotated by about 90°, so that a part hook element 98 surrounds the bearing ring 96, while a part hook element 99 surrounds the lower end face 7 of the casing and engages into the recess 97.

FIGS. 10a and 10b illustrate a tenth exemplary embodiment of a connection according to the invention of the suspension strut 5 to a wheel carrier 101 having a receptacle 102. In these embodiments, a lower end of the receptacle 102 is likewise bent over such as to give rise to a bearing ring 103 for the end face 7 of the suspension strut 5. In both variants of the wheel carrier 101, a bolt 104 of the suspension strut 5 is secured axially by clamping rings 105. The clamping ring 105 according to FIG. 10a is a shaft securing ring 106, while, in the variant illustrated in FIG. 10b, a spring ring 107 latches into a corresponding groove 108 in the bolt 104 and secures the suspension strut axially in the lower region.

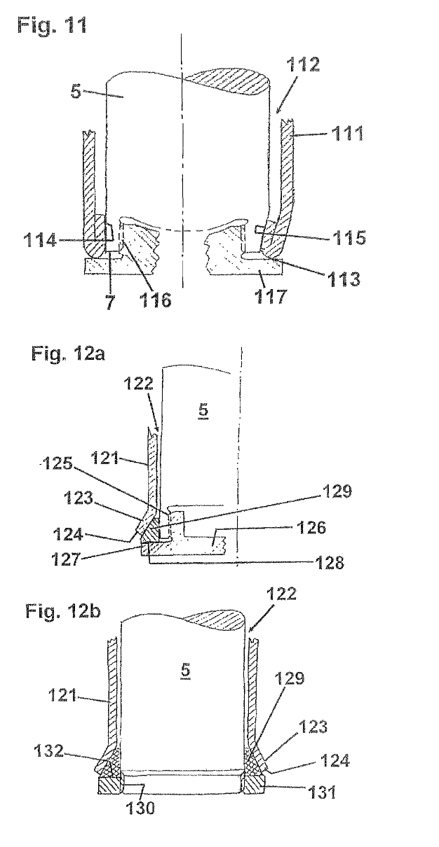

FIG. 11 illustrates an eleventh exemplary embodiment of a connection according to the invention of the suspension strut 5 to a wheel carrier 111 having a receptacle 112. In this embodiment, a lower end 113 of the wheel carrier 111 is bent over inward, specifically in such a way that either a cylindrical seat 114 for the suspension strut 5 is generated, as illustrated in the left half of FIG. 11, or a conical seat surface 115 is obtained, as illustrated in the right half of FIG. 11. Incorporated into a lower region of the suspension strut 5 is an internal thread 116 into which is screwed a screw cover 117 which secures the suspension strut 5 to the wheel carrier 111, and in this case the upper connection of the suspension strut 5 to the wheel carrier 111 may take place by means of a connection, such as is illustrated and has been described in the other embodiments.

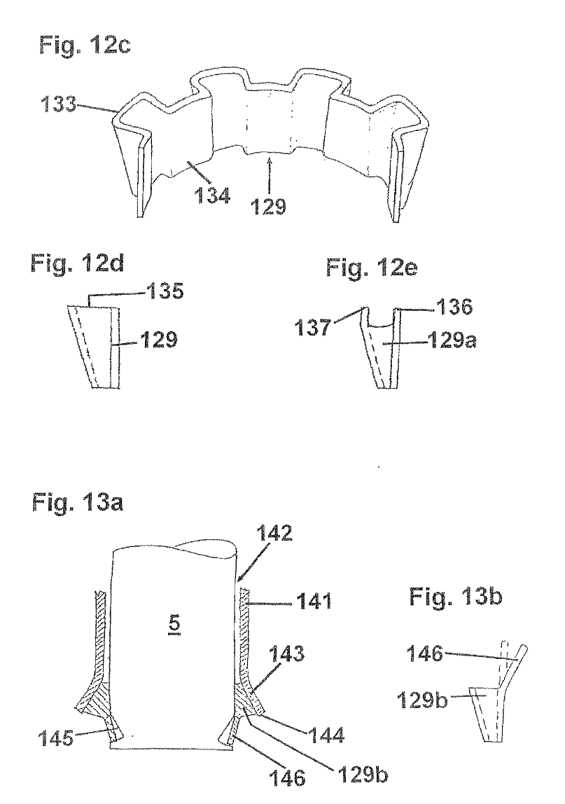

FIGS. 12a and 12b illustrate a twelfth exemplary embodiment of a connection according to the invention of a suspension strut 5 to a wheel carrier 121 having a receptacle 122. In this embodiment, a lower end 123 of the wheel carrier 121 is bent outward into a set-out cone 124. FIG. 12a illustrates a first variant in which, in a similar way to the embodiment according to FIG. 11, the lower region of the suspension strut 5 has incorporated into it an internal thread 125 into which a screw cap 126 is screwed. A margin 127 projects radially beyond the suspension strut 5 and forms a (tension) surface 128 which tensions a conical ring 129. This embodiment, which may be combined with an upper connection according to other embodiments, affords the advantage that the seat of the suspension strut 5 can be shifted far downward axially. A modification of this connection is illustrated in FIG. 12b. In this design variant, too, a lower end 123 of the wheel carrier 121 is bent outward into a set-out cone 124. In contrast to the variant according to FIG. 12a, the suspension strut 5 has at its lower end an external thread 130, onto which is screwed a nut 131 which tensions the conical ring 129 via a (tension) surface 132. An advantage of this refinement is the utilization of the full constructional length of the internal structure, along with a minimal loss of space.

FIGS. 12c to 12e illustrate the conical ring 129 in detail. The conical ring 129 is a sheet metal formed part which has radially running and meandering ribs 133, 134. Via the ribs 133, 134, it becomes possible to have a tangential movability, that is to say a variation in diameter when the suspension strut 5 is pressed or screwed into the receptacle 132 of the wheel carrier 131. So that the nut 126 or 131 can be tightened reliably, the conical ring 129 may be closed with a contact surface 135, as illustrated in FIG. 12d.

FIG. 12e illustrates a modification of a conical ring 129a. This corresponds largely to the ring 129 illustrated in FIG. 12c, but, in contrast to the latter, is designed as a ring with open ends 136, 137.

Alternatively to the rings 129, 129a, a profiled wire may be shaped as an open ring with open ends. The open ends of the profiled wire ring allows a change in diameter necessary for tensioning.

FIG. 13a illustrates a thirteenth exemplary embodiment of a connection according to the invention of the suspension strut 5 to a wheel carrier 141 having a receptacle 142. In this embodiment, too, a lower end 143 of the wheel carrier 141 is bent outward into a set-out cone 144. In contrast to the embodiment according to FIGS. 12a and 12b, the suspension strut 5 has no thread at its lower end, but, instead, a wedge-shaped groove 145 is cut into the casing 6 of the suspension strut or is pressed into the casing 6 by means of a forming method.

A conical ring 129b ensures the axial connection of the suspension strut 5 to the wheel carrier 141. This conical ring 129b, which is shown in detail in FIG. 13b, is similar to the conical rings 129 and 129a, but, in contrast to these, has claws 146 which engage into the groove 145. The claws 146 and the groove 145 are expediently designed such that an increasingly firm fit is established during operation.

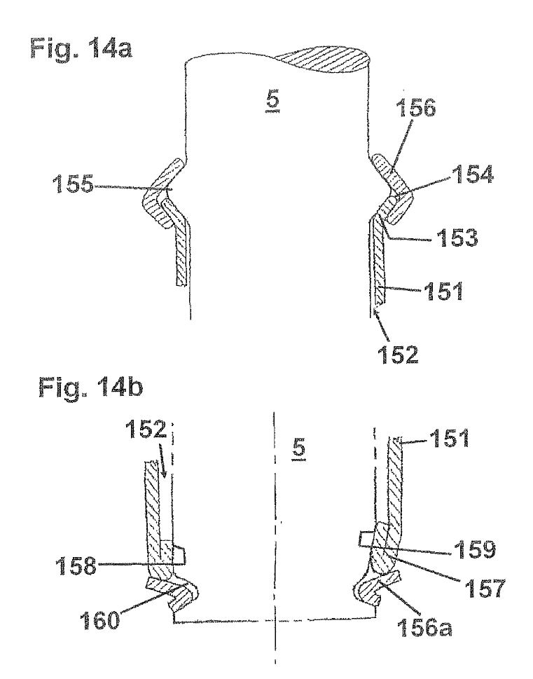

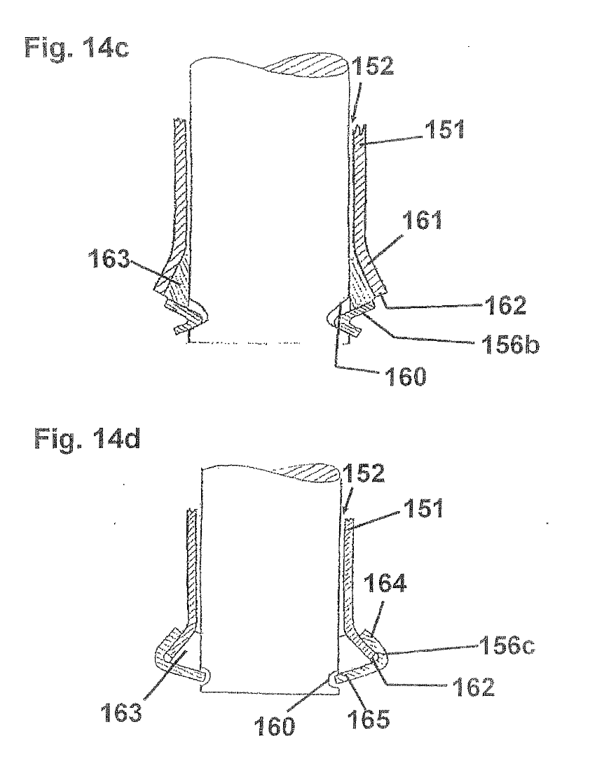

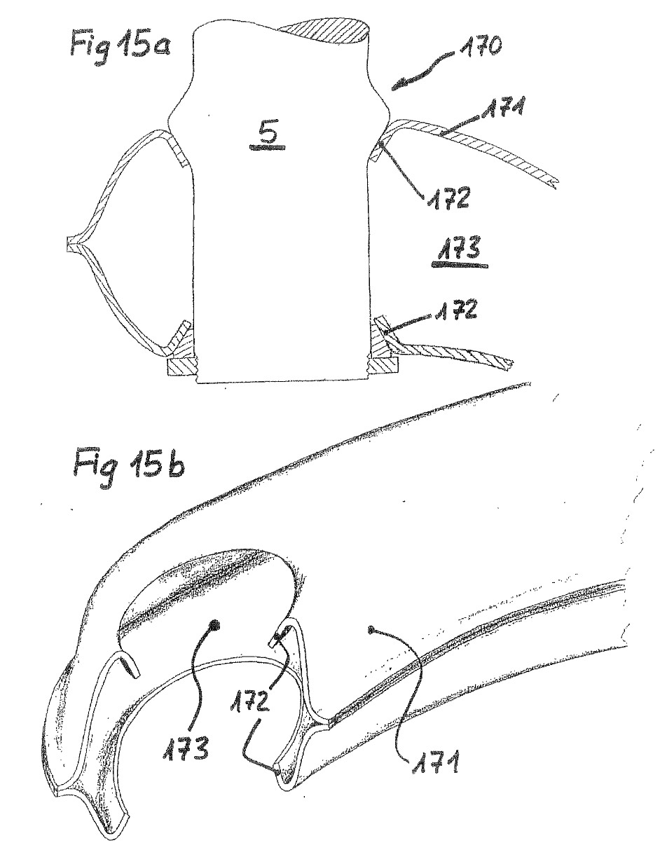

FIGS. 14a to 14d illustrate a fourteenth exemplary embodiment of a connection according to the invention of the suspension strut 5 to a wheel carrier 151 having a receptacle 152. The embodiments shown in FIGS. 14a to 14d have in common the fact that V-shaped tension bands or V-shaped rings are used for connecting the suspension strut 5 to the wheel carrier 151.

FIG. 14a illustrates an upper connection of the suspension strut 5 to the wheel carrier 151. Similarly to the embodiments illustrated in FIGS. 3, 4a and 4b, the wheel carrier 151 has an upper end 153 with a conically widened mouth 154, while the suspension strut 5 has a double-conical protuberance or a double-conical ring 155. The mouth 154 and the double-conical ring 155 or double-conical protuberance 155 are positively connected to one another and secured axially by means of a V-band 156.

FIG. 14b illustrates a lower connection of the suspension strut 5 to the wheel carrier 151 having a receptacle 152. In this embodiment, similarly to the embodiment shown in FIG. 11, a lower end 157 of the wheel carrier 151 is bent inward, specifically in such a way that either a cylindrical seat 158 for the suspension strut 5 is generated, as illustrated in the left half of FIG. 14b, or a conical seat surface 159 is obtained, as shown in the right half of FIG. 14b. A groove 160 is introduced into the casing 6 and serves for receiving a V-band 156a which tensions and secures the suspension strut 5 axially against the wheel carrier 151.

A modification of the refinement illustrated in FIG. 14b is shown in FIG. 14c. Similarly to the exemplary embodiments illustrated in FIGS. 12a, 12b and 13, a lower end 161 of the wheel carrier 151 is bent outward into a set-out cone 162. Inserted into the latter is a bevel ring 163 which is braced against the wheel carrier 151 by means of a V-band 156b, the tip of which engages into the groove 160, and thus secures the suspension strut 5 to the wheel carrier 151.

A modification of the embodiment shown in FIG. 14c is illustrated in FIG. 14d. In this case, a V-band 156c is arranged such that one leg 164 of the V-band 156c surrounds the set-out cone 163, while the other leg 165 engages into the groove 160 of the suspension strut 5 and thus ensures the axial connection of the suspension strut 5 to the wheel carrier 151.

FIGS. 15a and b illustrate a further exemplary embodiment of a connection 170 according to the invention of a suspension strut 5 to a wheel carrier 171. In an alternative to the connections illustrated previously, here, the sheet metal margins 172 of the wheel carrier 171 are bent over inward, that is to say toward the cavity 173 of the wheel carrier 171. The lower fixing of the suspension strut 5 in the wheel carrier 171 takes place in a similar way to the version according to FIGS. 12a and b. The upper fixing of the suspension strut 5 in the wheel carrier 171 takes place in a similar way to the version according to FIG. 3.

The advantage of this embodiment is that production can be carried out more easily and more simply, since the sheet metal margins 172 do not first have to be set up and bent up outward, but are produced at the same time as the forming of the structure. A further advantage in this case is that sharp edges on the sheet metal margins 172 are not exposed. The risk of injury in the event of maintenance or assembly is thereby reduced.

### LIST OF REFERENCE SYMBOLS

1 Wheel carrier
2 Receptacle
3 Longitudinal slot
4 Bore
5 Suspension strut
6 Casing
7 Lower end face
11 Wheel carrier
12 Receptacle
13 Reception cup
14 Shoulder
15 Bore
16 Threaded bolt
17 Draw-in sleeve
21 Wheel carrier
22 Receptacle
23 Double cone
24 Mouth
25 Shoulder
26 Reception cup
27 Casing
28 Rib
29 Collar
30 Shoulder
31 Wheel carrier
32 Receptacle
33 Reception cup
34 Mouth
35 Double-conical ring
36 End
36a End
37 Conical disk
38 Threaded bolt
39 Nut
40 Annular sleeve
41 Collar
42 Conical ring
43 Cup spring
44 Double-conical ring
45 Conical surface
46 Conical surface
47 Slope
51 Wheel carrier
52 Receptacle
53 Upper region
54 Upper end
55 Edging
56 Edging
57 Bore
58 Bore
59 tab
60 Receptacle
61 Wheel carrier
62 Receptacle
63 Mouth
64 Bead
65 Boss
66 Boss
67 Bead
71 Wheel carrier
72 Receptacle
73 Upper end
74 Screw
75 Recess
76 Recess
77 Sheet metal tab
78 Sheet metal tab
79 Threaded bore
80 Depression
81 Wheel carrier
82 Receptacle
83 Claw ring
84 Claws
85 Claws
86 Lower edge
87 Recess
88 End edge
89 Step
90 Step
91 Wheel carrier
92 Receptacle
93 Claw ring
94 Hook element
95 Lower end
96 Bearing ring
97 Recess
98 Part hook element
99 Part hook element
101 Wheel carrier
102 Receptacle
103 Bearing margin
104 Bolt
105 Clamping ring
106 Shaft securing ring
107 Spring ring
108 Groove
111 Wheel carrier
112 Receptacle
113 Lower end
114 Cylindrical seat
115 Conical seat surface
116 Internal thread
117 Screw cover
121 Wheel carrier
122 Receptacle
123 Lower end
124 Set-out cone
125 Internal thread
126 Screw cover
127 Margin
128 Seat surface
129 Conical ring
129a Conical ring
130 External thread
131 Nut
132 Seat surface
133 Rib
134 Rib
135 Contact surface
136 End
137 End
141 Wheel carrier
142 Receptacle
143 Lower end
144 Set-out cone
145 Groove
146 Claw
151 Wheel carrier
152 Receptacle
153 Upper end
154 Mouth
155 Double-conical ring
156 V-band
156a V-band
156b V-band
156c V-band
157 Lower end
158 Cylindrical seat
159 Conical seat surface
160 Groove
161 Lower end
162 Set-out cone
163 Bevel ring
164 Leg
165 Leg
170 Connection
171 Wheel carrier
172 Sheet metal margins
173 Cavity

1. Connection of a suspension strut to a wheel carrier of a motor vehicle, comprising a wheel carrier being provided with a receptacle for the releasable connection of a lower end of a suspension strut, and the lower end of the suspension strut being mounted coaxially in the receptacle, wherein the wheel carrier is a sheet metal formed part, onto which the receptacle of the suspension strut is formed in one piece, the receptacle having formed onto it holding means which are connectable releasably to holding means of the suspension strut.

2. The connection according to claim 1, wherein the holding means of the receptacle are formed on an axially upper end of the receptacle.

3. The connection according to claim 1, wherein the holding means of the receptacle are formed on an axially lower end of the receptacle.

4. The connection according to claim 1, wherein the holding means of the receptacle are formed on an axially lower end and on an axially upper end of the receptacle.

5. The connection according to claim 1, wherein the holding means of the suspension strut are formed on an axially upper end of the suspension strut.

6. The connection according to claim 1, wherein the holding means of the suspension strut are formed on an axially lower end of the suspension strut.

7. The connection according to claim 1, wherein the holding means of the suspension strut are formed on an axially upper end and on a lower end of the suspension strut.

8. The connection according to claim 1, wherein the holding means of the receptacle are connectable to the holding means of the suspension strut by means of a screw connection.

9. The connection according to claim 8, wherein the screw connection has a threaded bolt, a tangential screw, a radial screw or a screw cap.

10. The connection according to claim 1, wherein the holding means of the receptacle are connectable to the holding means of the suspension strut by means of at least one claw ring.

11. The connection according to claim 1, wherein the holding means of the receptacle are connectable to the holding means of the suspension strut by means of at least one V-band.

12. The connection according to claim 1, wherein the holding means of the receptacle are formed by a longitudinal slot and at least one bore, and in that the holding means of the suspension strut are formed by a screw bolt which can be led through the at least one bore.

13. The connection according to claim 1, wherein the holding means of the receptacle is a reception cup with a shoulder and with a bore, through which a threaded bolt of the suspension strut can be led, and in that the holding means of the suspension strut is a threaded bolt, the nut of which can be tensioned against the receptacle.

14. The connection according to claim 13, wherein a draw-in sleeve, preferably consisting of thin sheet metal, is arranged around the casing of the suspension strut.

15. The connection according to claim 1, wherein the wheel carrier has a receptacle with a double cone which consists of an upper conically widened mouth and of a conical shoulder of a reception cup, the mouth and shoulder forming the holding means of the receptacle.

16. The connection according to claim 15, wherein the suspension strut has a casing with a rib, the collar of which bears against the conically widened mouth of the reception cup, while a shoulder of the lower end of the casing bears against the shoulder of the wheel carrier.

17. The connection according to claim 1, wherein the receptacle of the wheel carrier has a reception cup with a conically designed upper mouth, against which a conical portion of the suspension strut, particularly formed by a ring, particularly by a double-conical ring or a conical molding of the suspension strut, is supported.

18. The connection according to claim 17, wherein the reception cup is connected to the wheel carrier by means of a weld.

19. The connection according to claim 17, wherein the reception cup is produced in one piece with the wheel carrier.

20. The connection according to claim 17, wherein a lower end of the reception cup is angled radially inward such that it forms a radially inwardly-directed conical seat surface for the conical disk which is braced against the conical seat surface of the lower end of the reception cup by means of the threaded bolt and a nut.

21. The connection according to claim 17, wherein a lower end of the reception cup is angled radially outward and forms a conical seat surface for the holding means of the suspension strut, the holding means being designed as an annular sleeve with a collar, which annular sleeve is acted upon with pressure by the nut.

22. The connection according to claim 17, wherein a lower end of the reception cup is angled radially outward and forms a conical seat surface for a holding means of the suspension strut, the holding means being designed as a conical ring which is acted upon with pressure by a cup spring.

23. The connection according to claim 17, wherein a lower end of the reception cup is angled radially outward and forms a conical seat surface for the holding means of the suspension strut, the holding means being designed as a double-conical ring, one conical surface of which presses against the lower end and the other conical surface of which presses against a slope of the suspension strut.

24. The connection according to claim 1, wherein the receptacle has radially on the outside, as holding means, a double edging with at least one bore which is in alignment with at least one bore of at least one tab formed on the suspension strut, the tab being the holding means of the suspension strut and being connectable to the edgings preferably by means of a screw.

25. The connection according to claim 1, wherein the suspension strut has a receptacle which is connectable to the receptacle, the receptacle having beads and/or bosses which, together with correspondingly shaped bosses and/or beads of the receptacle of the wheel carrier, form an antitwist device.

26. The connection according to claim 25, wherein the receptacle of the suspension strut forms the casing of the suspension strut.

27. The connection according to claim 1, wherein a screw led tangentially through the wheel carrier is the holding means of the suspension strut, a recess being provided in the casing of the suspension strut and a recess being provided in the receptacle of the wheel carrier, through which recesses a screw is led.

28. The connection according to claim 1, wherein a screw is led radially through a threaded bore delimited by sheet metal tabs of the receptacle and engages into a depression in the casing of the suspension strut.

29. The connection according to claim 1, wherein a claw ring is used for holding the lower end of the suspension strut axially in the receptacle of the wheel carrier.

30. The connection according to claim 29, wherein the claw ring, preferably produced as a formed part, has inwardly-directed claws and radially outwardly-directed claws which bear against a lower edge of the receptacle of the wheel carrier, the radially inwardly-directed claws latching into a recess in the casing, an upper end edge of the claw ring being mounted in a step of the casing.

31. The connection according to claim 29, wherein the radially outwardly-directed claws bear against a lower edge of the wheel carrier, the radially inwardly-directed claws snapping into a recess in the casing, and an upper end edge of the claw ring being mounted in a step of the casing.

32. The connection according to claim 29, wherein a claw ring has an S-shaped cross-sectional shape and can be introduced at least partially on a lower end of the receptacle of the wheel carrier, the lower end being bent over in such a way as to give rise to a bearing ring for the lower end face of the casing of the suspension strut.

33. The connection according to claim 1, wherein a lower end of the receptacle of the wheel carrier is bent over in such a way as to form a bearing ring for the end face of the suspension strut, a bolt of the suspension strut being fixed axially by clamping rings.

34. The connection according to claim 33, wherein the clamping ring is designed as a shaft securing ring or as a spring ring, the clamping ring latching into a corresponding groove in the bolt.

35. The connection according to claim 1, wherein the lower region of the casing of the suspension strut has incorporated into it an internal thread into which a screw cover is screwed, with the result that the suspension strut is fixed to the wheel carrier.

36. The connection according to claim 1, wherein the lower region of the suspension strut has incorporated into it an internal thread into which a screw cover is screwed, a margin of the screw cover projecting radially beyond the suspension strut and forming a surface for a conical ring.

37. The connection according to claim 1, wherein a lower end of the wheel carrier is bent outward into a set-out cone, and in that the suspension strut has at its lower end an external thread, onto which is screwed a nut which forms a surface tensioning the conical ring which is brought at least partially to bear against the set-out cone.

38. The connection according to claim 1, wherein a lower end of the wheel carrier is bent outward into a set-out cone, the suspension strut being provided in its casing with a wedge-shaped groove, into which claws of a conical ring engage.

39. The connection according to claim 1, wherein the wheel carrier has an upper end with a conically widened mouth, and in that the suspension strut has a double-conical ring or a correspondingly shaped molding on the suspension strut, the mouth and double-conical ring or molding being positively connected to one another and secured axially by means of a V-band.

40. The connection according to claim 1, wherein a lower end of the wheel carrier is bent inward into a cylindrical seat or into a conical seat surface for the suspension strut, a groove being introduced into the casing, into which groove a V-band engages, with the result that the suspension strut is tensioned and secured axially against the wheel carrier.

41. The connection according to claim 1, wherein a lower end of the receptacle of the wheel carrier is bent radially outward into a set-out cone, the cone having inserted into it a bevel ring which is braced against the wheel carrier by means of a V-band, the tip of which engages into the groove, and secures the suspension strut to the wheel carrier.

42. The connection according to claim 1, wherein a V-band is arranged on the receptacle and on the suspension strut such that one leg of the V-band surrounds the set-out cone, while another leg engages into the groove of the suspension strut and secures the axial connection of the suspension strut to the receptacle of the wheel carrier.

43. The connection according to claim 1, wherein the receptacle of the wheel carrier has sheet metal margins bent over inward, a rib of the suspension strut being supported on one of the sheet metal margins, in particular on an upper sheet metal margin.
